(19) United States
(12) Patent Application Publication
(10) Pub. No.: US 2023/0196120 A1
(43) Pub. Date: Jun. 22, 2023

(54) METHOD, DEVICE, TERMINAL, AND STORAGE MEDIUM FOR REUSING PARAMETERS OF A DEEP LEARNING MODEL

(71) Applicant: SHENZHEN INSTITUTES OD ADVANCED TECHNOLOGY, SHENZHEN (CN)

(72) Inventors: DONG LIANG, SHENZHEN (CN); YANJIE ZHU, SHENZHEN (CN); WEI WANG, SHENZHEN (CN); XIN LIU, SHENZHEN (CN); HAIRONG ZHENG, SHENZHEN (CN)

(21) Appl. No.: 18/106,988

(22) Filed: Feb. 7, 2023

Related U.S. Application Data
(63) Continuation of application No. PCT/CN2020/117656, filed on Sep. 25, 2020.

(30) Foreign Application Priority Data
Aug. 7, 2020 (CN) 202010786350.0

(51) Int. Cl. G06N 3/096

(52) U.S. Cl. CPC G06N 3/096

(57) ABSTRACT

A method, device, terminal, and storage medium for reusing parameters of a deep learning model are disclosed, the method including: training a target model with a preset training set; obtaining a pre-trained original model; obtaining correspondences between layers of the target model and the original model having identical network structures, and parameter correspondences between corresponding layers; extracting multiple original model parameters from layers of the original model each having an identical network structure with respective layer of the target model; based on the parameter correspondences, replacing the corresponding parameters of the target model one by one with the original model parameters, validating the replaced target model with the preset validation set, and when the validation is passed, recording that the corresponding original model parameter is reusable; and using all reusable original model parameters to replace the corresponding parameters in the target model to obtain and train a new target model.

### CROSS-REFERENCE TO RELATED APPLICATIONS

This application is a continuation of co-pending International Patent Application Number PCT/CN2020/117656, filed on Sep. 25, 2020, the disclosure of which is incorporated herein by reference in its entirety.

### TECHNICAL FIELD

This application relates to the technical field of deep learning models, and more particularly relates to a method, a device, a terminal, and a storage medium for reusing parameters of a deep learning model.

### BACKGROUND

The description provided in this section is intended for the mere purpose of providing background information related to the present application but doesn’t necessarily constitute prior art.

It is well known that deep learning requires a large amount of labeled data for training, but some data is difficult to obtain, and labeling data requires a lot of manpower. Therefore, how to use as little data as possible to achieve the goal is one of the frontiers of deep learning, and parameter reuse is an important strategy to solve this problem.

There are currently two main ways to solve the problem of how to use a small amount of data for training:

1. Transfer learning. It is a machine learning method that uses the model parameters developed for one task as the starting point for the training of parameters of a second model. Network-based deep transfer learning refers to reusing part of the pre-trained network for the original domain, including its network structure and parameters, as part of the deep neural network for the target domain.

2. Semi-supervised learning. Semi-supervised learning is an algorithm that combines supervised learning and unsupervised learning. It uses both labeled data and unlabeled data for learning. Nowadays, one of the popular methods in deep learning applications is unsupervised pre-training, including using all data to train and reconstruct an autoencoder network, and then using the parameters of the autoencoder network as initial parameters to fine-tune with labeled data.

However, both transfer learning and semi-supervised learning have the same problem: the blindness of selection of reuse parameters, meaning they temporarily fail to well select reusable parameters, resulting in poor model reuse.

### SUMMARY

In view of the above, the present application provides a method, a device, a terminal, and a storage medium for reusing parameters of a deep learning model to solve the problem that existing parameter reuse methods cannot avoid the blindness of selection of reusable parameters.

To solve the above technical problems, a technical solution adopted by this application is to provide a parameter reuse method of a deep learning model, including: training a target model based on a pre-configured data set, the data set including a training set and a validation set; obtaining a pre-trained original model, where part or all network structures are identical between the target model and the original model; obtaining correspondences between layers of the target model and the original model having identical network structures, as well as the parameter correspondences between the corresponding layers; extracting multiple original model parameters from layers of the original model each having an identical network structure with the respective layer of the target model; based on the parameter correspondences, using the plurality of original model parameters to replace the corresponding parameters in the target model one by one, and validating the replaced target model on the validation set, and each time when the validation is passed, recording the corresponding original model parameter can be reused; using all reusable original model parameters to replace the corresponding parameters in the target model to obtain a new target model, and then training the new target model.

In some embodiments, the operations of validating the replaced target model, and when the validation is passed, recording that the original model parameter can be reused include: obtaining a first result obtained by training the target model with the training set; validating the replaced target model with the validation set, and recording a second result of the validation; determining whether the difference between the first result and the second result lies within a preset range; when the difference between the first result and the second result lies within the preset range, determining that the validation is passed, and that the recorded original model parameter can be reused.

In some embodiments, the operation of training the new target model includes: directly using the training set to train the new target model.

In some embodiments, the operation of training of the new target model includes: freezing in the new target model the reusable parameters of the original model, and then using the training set to train the new target model.

In some embodiments, the method further includes the following operation prior to training the target model with the pre-configured data set: preprocessing the data set.

In some embodiments, another technical solution adopted by this application is to provide a device for reusing parameters of a deep learning model, including: a training module, used to train a target model based on a pre-configured data set, where the data set includes a training set and a validation set; a first acquisition module, used to obtain a pre-trained original model, where part or all of the network structures are identical between the target model and the original model; a second acquisition module, used to obtain the correspondences between the layers of target model and the original model having identical network structures, as well as the parameter correspondences between the corresponding layers; an extraction module, used to extract multiple original model parameters from layers of the original model each having an identical network structure with the respective layer of the target model; a validation module, used to replace the corresponding parameters in the target model with each original model parameter one by one based on the parameter correspondences, validating the replaced target model on the validation set, and recording the corresponding original model parameter as reusable when the validation is passed; a transfer module, used to replace the corresponding parameters in the target model with all reusable parameters of the original model to obtain a new target model, and then train the new target model.

In some embodiments, another technical solution adopted by this application is to provide a method for reusing parameters of a deep learning model, the method including: training a target model with a pre-configured first data set, and training an original model with a pre-configured second data set, where part or all of the network structures are identical between the target model and the original model, and the first data set includes a first training set and a first validation set; obtaining the correspondences between the layers of the target model and the original model having identical network structures, as well as the parameter correspondences between the corresponding layers; extracting multiple original model parameters from layers of the original model each having an identical network structure with the respective layer of the target model; replacing the corresponding parameters in the target model with each original model parameter one by one based on the parameter correspondences, validating the replaced target model on the first validation set, and recording that the corresponding original model parameter can be reused when the validation is passed; using all reusable original model parameters to replace the corresponding parameters in the target model to obtain a new target model, and then training the new target model.

To solve the above technical problems, another technical solution adopted by this application is to provide a device for reusing parameters of a deep learning model, the device including: a training module, used to train a target model with a pre-configured first data set, and train and obtain an original model with a pre-configured second data set, where part or all of the network structures are identical between the target model and the original model, and the first data set includes a first training set and a first validation set; an acquisition module, used to obtain the correspondences between the layers of the target model and the original model having identical network structures, and as well as the parameter correspondences between the corresponding layers; an extraction module, used to extract multiple original model parameters from layers of the original model each having an identical network structure with the respective layer of the target model; an validation module, used to replace the corresponding parameters in the target model with each original model parameter one by one based on the parameter correspondences, validating the replaced target model on the first validation set, and when the validation is passed, recording that the corresponding original model parameter can be reused; and a transfer module, used to replace the corresponding parameters in the target model with all reusable parameters of the original model to obtain a new target model, and then training the new target model.

To solve the above technical problems, yet another technical solution adopted by the present application is to provide a terminal, which includes a processor and a memory coupled to the processor, where the memory stores program instructions for implementing the above-mentioned method for reusing parameters of a deep learning model, and the processor is used to execute the program instructions stored in the memory to realize parameter reuse across different deep learning models.

To solve the above-mentioned technical problems, still another technical solution adopted by the present application is to provide a storage medium storing program files capable of implementing the above-mentioned method for reusing parameters of a deep learning model.

Beneficial effects of the present application are as follows. In the method of reusing parameters of a deep learning model according to the first embodiment of the present application, the initial training is performed based on the preset data set, and after the target model is obtained, the pre-trained original model having network structures that are partially or totally identical with the network structures of the target model is obtained. Then the parameters of layers of the original model having identical network structures to the corresponding layers of the target model are substituted to the target model on a one-by-one basis, before the replaced target model is validated on the validation set. If the validation is passed, it is considered that the parameter can be reused from the original model to the target model. After all parameters are validated, all reusable parameters are loaded into the target model and trained again to obtain a new target model. As such, it is possible to obtain a model with good effect by reusing parameters even if the data set for training the target model is insufficient. Furthermore, the method of screening out reusable parameters through parameter-by-parameter validation makes the selection of reusable parameters more purposeful and helps to select the most suitable reusable parameters, thereby avoiding blind selection of reusable parameters.

### BRIEF DESCRIPTION OF DRAWINGS

FIG. 1 is a schematic flow chart of a method for reusing parameters of a deep learning model according to a first embodiment of the present application.

FIG. 2 is a schematic diagram of functional modules of a device for reusing parameters of a deep learning model according to the first embodiment of the present application.

FIG. 3 is a schematic flow chart of a method for reusing parameters of a deep learning model according to a second embodiment of the present application.

FIG. 4 is a schematic diagram of functional modules of a device for reusing parameters of a deep learning model according to the second embodiment of the present application.

FIG. 5 is a schematic diagram of a terminal according to an embodiment of the present application.

FIG. 6 is a schematic diagram of a storage medium according to an embodiment of the present application.

### DETAILED DESCRIPTION OF EMBODIMENTS

For a better understanding of the objectives, technical solutions, and advantages of the present application, hereinafter the present application will be described in further detail in connection with the accompanying drawings and some illustrative embodiments. It is to be understood that the specific embodiments described here are intended for the mere purposes of illustrating this application, instead of limiting.

Terms “first”, “second”, “third” or the like in this application are merely used for illustrative purposes, and shall not be construed as indicating relative importance or implicitly indicating the number of technical features specified. Thus, unless otherwise specified, the features defined by “first”, “second”, or “third” may explicitly or implicitly include at least one of such feature. As used herein, the term “multiple” or “a plurality of” means at least two, such as two, three, etc., unless otherwise expressly and specifically defined. Note that all directional or orientational indication (such as up, down, left, right, front, back.) as used in the embodiments disclosed herein are merely used to explain the relative positional relationships and movement of the components in a specific posture (as shown in the figures). Should the particular posture changes, the directional or orientational indication would also change accordingly. In addition, the terms “comprise”, “comprising”, “include”, “including”, “having” and any variations thereof are intended to mean non-exclusive inclusion. For example, a process, method, system, product, or device comprising a series of steps or units will not be limited to the listed steps or units, but may In some embodiments further include unlisted steps or units, or may In some embodiments further include other steps or units inherent to the these processes, methods, products or devices.

Reference herein to an “embodiment” means that a particular feature, structure, or characteristic described in connection with the embodiment can be included in at least one embodiment of the present application. The occurrences of this phrase in various places in the specification are not necessarily all referring to the same embodiment, nor are a separate or an alternative embodiment mutually exclusive of other embodiments. It is understood explicitly and implicitly by those skilled in the art that the embodiments described herein can be combined with other embodiments.

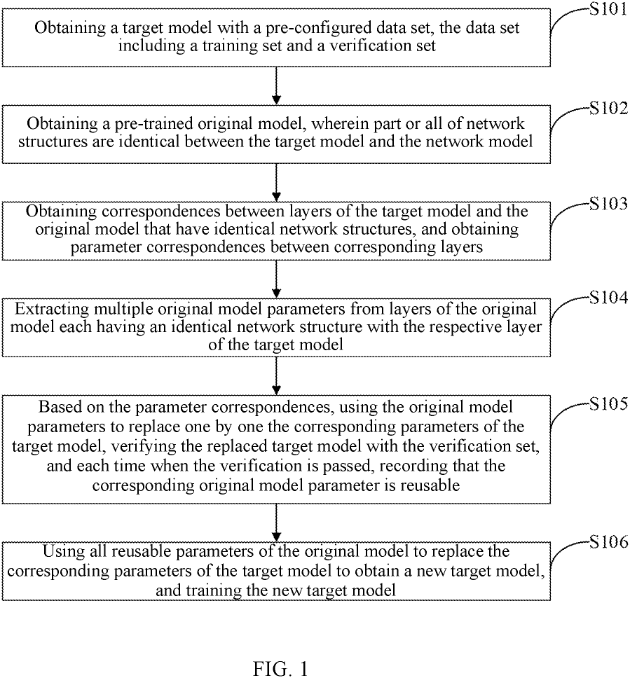

FIG. 1 is a schematic flowchart of a method for reusing parameters of a deep learning model according to a first embodiment of the present application. It should be noted that the method of the present application is not to be limited to the flow sequence shown in FIG. 1 if substantially the same result is obtained. As shown in FIG. 1, the method includes steps:

Step S101: training a target model based on a pre-configured data set, the data set including a training set and a validation set.

It should be noted that this data set is collected according to the task requirements. For example, when the task is to realize recognition of cat and dog images, multiple images of cats and dogs need to be prepared in advance. The data set includes a training set and a validation set, where the training set is used for model training, and the validation set is used to validate the trained model.

In step S101, after the pre-configured data set is obtained, the data set is used for deep learning training, so as to obtain the target model.

Further, in order to ensure the training effect of the model, the method may further include the following operation prior to training the target model with the pre-configured data set: preprocessing the data set.

Specifically, preprocessing the data set specifically includes: normalization and standardization of data, etc. If the data volume is too small, the data set can also be expanded by means of graphic rotation and cropping.

Step S102: Obtaining a pre-trained original model, where part or all of the network structures are identical between the target model and the pre-trained original model.

It should be noted that the original model is a pre-trained model, and part or all of the network structures should be identical between the target model and the original model. Otherwise, parameter reuse is not possible. For example, a deep learning model may include an activation function layer, a convolutional layer, a fully connected layer, a pooling layer, a BN (Batch Normalization) layer, etc., where some or all of the convolutional layers or BN layers must have the same network structure.

Step S103: Obtaining the correspondence between the layers of the target model and the original model having identical network structures, and the parameter correspondences of the corresponding layers.

In step S103, after obtaining the original model, the layers in the target model and the original model that have identical network structures are first determined, and then one-to-one correspondences are established between these layers, and further one-to-one correspondences are established between the parameters in the layers.

Step S104: Extracting multiple original model parameters from layers in the original model each having an identical network structure with the respective layer of the target model.

In step S104, after determining the layers with identical network structures, all parameters of the layers with identical network structures are extracted from the original model to obtain a plurality of original model parameters.

Step S105: Based on the parameter correspondences, each original model parameter is used to replace the corresponding parameter in the target model one by one, and the replaced target model is validated on the validation set, and when the validation is passed, it is recorded that the original model parameters can be reused.

In step S105, after extracting a plurality of original model parameters from the original model, based on the parameter correspondences, the original model parameters are used to replace the parameters in the target model corresponding to the original model parameters to obtain the replaced target model. Without retraining the replaced target model, the validation set is directly used to validate the replaced target model. When the validation is passed, it is considered that the original model parameters can be reused in the target model. When the validation fails, it is considered that the parameters of the original model cannot be reused in the target model. The above steps are repeated until every original model parameter is validated, finally obtaining all the original model parameters that can be reused in the target model.

It should be noted that after each original model parameter is validated, the target model needs to be restored to its original state before the validation of the next original model parameters is performed, meaning only one variable in the target model is always maintained, so as to effectively validate whether each original model parameter can be reused.

For example, the parameters Runningmean, Runningvar, weight, and bias of the BN layer are represented by RM, RV, RW, and RB, respectively, and the parameters weight and bias of the convolutional layer are represented by W and B, respectively. Assuming that there are BN layers and convolutional layers with identical network structures between the target model and the original model, the original model parameters RM₁, RV₁, RW₁, RB₁ of the BN layer and the original model parameters W₁, B₁ of the convolutional layer of the original model are extracted. First, regarding the BN layer, find in the target model the BN layer of the target model corresponding to the BN layer of the original model, and find out the target model parameters RM₂, RV₂, RW₂, RB₂, and then use RM₁ to replace RM₂, and validate the replaced target model directly on the validation set without retraining the replaced target model. When the validation is passed, record that RM₁ can be reused, then restore the replaced target model to its original state, replace RV₂ with RV₁, and perform validation again until all of the four parameters of RM₁, RV₁, RW₁, and RB₁ are validated. Then, regarding the convolution layer, find in the target model the convolution layer of the target model corresponding to the original model convolution layer, and find out the target model parameters W₂, B₂, and then use W₁ to replace W₂ and directly validate the replaced target model on the validation set without retraining the replaced target model. When the validation is passed, record that W₁ can be reused, and then the replaced target model is restored to its original state, and then B₂ is replaced with B₁, and the validation is performed again until both parameters W₁ and B₁ are validated. This enables layer-by-layer and parameter-by-parameter validation to facilitate selecting the most appropriate reusable parameters.

Further, in this embodiment, the operations of validating the replaced target model, and when the validation is passed, recording the reusable parameters of the original model include:

1. Obtaining a first result obtained by training the target model with the training set.

Specifically, after the data set is obtained, the data set is divided into a training set and a validation set, and then the training set is used to train the target model, and the first result obtained by the training of the target model is recorded.

2. Validating the replaced target model with the validation set, and record a second validation result.

Specifically, after replacing the corresponding parameters in the target model with the parameters of the original model, the replaced target model is validated using the validation set, and the second result obtained from the validation is recorded.

3. Determining whether the difference between the first result and the second result lies within a preset range.

4. When the difference between the first result and the second result lies within the preset range, determining that the validation is passed, and that the recorded original model parameter can be reused.

Specifically, the difference between the first structure and the second result is determined by comparison, and when the difference between the first result and the second result is within the preset range, the validation is passed, and the original model parameter is recorded as can be reused. When the difference between the first result and the second result is not within the preset range, the validation fails and the original model parameters cannot be reused.

Step S106: Using all reusable parameters of the original model to replace the corresponding parameters in the target model to obtain a new target model, and then training the new target model.

In step S106, after obtaining all reusable original model parameters through validation, use all reusable original model parameters to replace the corresponding parameters in the target model to obtain a new target model, and then use the data set to train the new target model.

In some embodiments, the operation of training the new target model includes: directly using the training set to train the new target model.

Specifically, when using the data set to train the new target model, the parameters reused in the new target model can be fine-tuned, so that the training effect of the new target model can be improved.

In some other embodiments, the operation of training the new target model may further include: freezing in the new target model the reusable parameters from the original model, and then using the training set to train the new target model.

It should be understood that this embodiment only raises the reuse of parameters between two models for illustration, but it is also applicable to the reuse of parameters between multiple models, which shall all fall in the scope of protection of the present application.

In the method of reusing parameters of a deep learning model according to the first embodiment of the present application, the initial training is performed based on the preset data set, and after the target model is obtained, the pre-trained original model having network structures that are partially or totally identical to the network structures of the target model is obtained. Then the parameters of layers of the original model having identical network structures to the corresponding layers of the target model are substituted to the target model on a one-by-one basis, before the replaced target model is validated on the validation set. If the validation is passed, it is considered that the parameter can be reused from the original model to the target model. After all parameters are validated, all reusable parameters are loaded into the target model and trained again to obtain a new target model. As such, it is possible to obtain a model with good effect by reusing parameters even if the data set for training the target model is insufficient. Furthermore, the method of screening out reusable parameters through parameter-by-parameter validation makes the selection of reusable parameters more purposeful and helps to select the most suitable reusable parameters, thereby avoiding blind selection of reusable parameters.

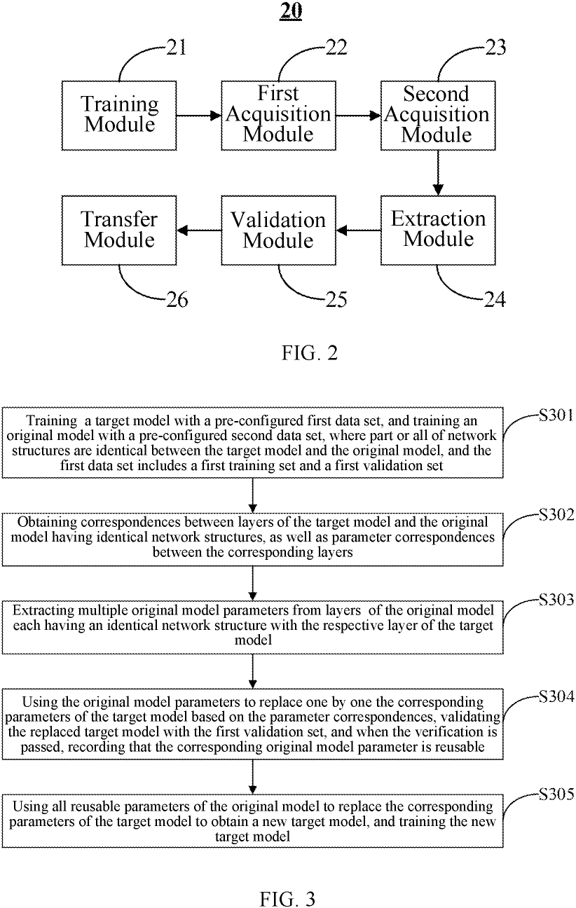

FIG. 2 is a schematic diagram of functional modules of a device for reusing parameters of a deep learning model according to the first embodiment of the present application. As shown in FIG. 2, the device 20 includes a training module 21, a first acquisition module 22, a second acquisition module 23, an extraction module 24, a validation module 25, and a transfer module 26.

The training module 21 is used to train a target model based on a pre-configured data set, where the data set includes a training set and a validation set.

The first acquisition module 22 is used to obtain a pre-trained original model, where part or all of the networks are identical between the target model and the original model.

The second acquisition module 23 is configured for obtaining the correspondence between the layers of the target model and the original model having identical network structures, and the parameter correspondences of the corresponding layers.

The extraction module 24 is used to extract multiple original model parameters from layers in the original model that have identical network structures.

The validation module 25 is used to use each original model parameter to replace the corresponding parameter in the target model one by one based on the parameter correspondences, and validate the replaced target model on the validation set, and when the validation is passed, recording that the original model parameters can be reused.

The transfer module 26 is used to replace the corresponding parameters in the target model with all reusable parameters of the original model to obtain a new target model, and then train the new target model.

In some embodiments, the training module 21 is further used to preprocess the data set prior to training and obtaining the target model with the pre-configured data set.

In some embodiments, the operation of the validation module 25 validating the replaced target model, and when the validation is passed, recording the reusable parameters of the original model may also include: obtaining a first result obtained by training the target model with the training set; validating the replaced target model with the validation set, and recording a second result of the validation; determining whether the difference between the first result and the second result lies within a preset range; When the difference between the first result and the second result lies within the preset range, determining that the validation is passed, and that the recorded original model parameters can be reused.

In some embodiments, the operation of training the new target model by the transfer module 26 may include directly using the training set to train the new target model.

In some embodiments, the operation of the transfer module 26 training the new target model can also include freezing in the new target model the reusable parameters of the original model, and then using the training set to train the new target model.

For other details of various modules of the device for reusing parameters of the deep learning model of the first embodiment implementing the technical solutions, refer to the foregoing description of the method for reusing parameters of the deep learning model of the first embodiment, which is not to be repeated here.

It should be noted that the embodiments in this specification are described in a progressive manner, where each embodiment focuses on the differences from other embodiments. For the same and similar parts in the various embodiments, refer to each other. As for the device-type embodiments, since they are basically similar to the method embodiments, the description thereof is relatively simple, and for related parts, refer to the corresponding parts of the description of the method embodiments.

FIG. 3 is a schematic flowchart of a method for reusing parameters of a deep learning model according to a second embodiment of the present application. It should be noted that the method of the present application is not to be limited to the flow sequence shown in FIG. 3 if substantially the same result is obtained. As shown in FIG. 3, the method includes steps:

Step S301: training a target model with a pre-configured first data set, and training an original model with a pre-configured second data set, where part or all of the network structures are identical between the target model and the original model, and the first data set includes a first training set and a first validation set.

In step S301, the first data set and the second data set may be exactly the same data set. When the first data set and the second data set are the same, the target model and the original model may be two models of the same data set for different tasks. In addition, the first data set and the second data set may also be two different data sets, and the target model and the original model may be two models of different data sets intended for the same task or different tasks. In this embodiment, the data volume of the first data set may be smaller than the data volume of the second data set.

In this embodiment, when the amount of data in the first data set is so small that it is difficult to train a model with a good effect, and the amount of data in the second data set is large and a model with a good effect can be trained, then after the original model is obtained through training with the second data set, the parameters of the original model can be reused in the target model obtained through training based on the first data set, thereby improving the training effect of the target model.

Step S302: Obtaining the correspondences between layers of the target model and the original model that have identical network structures, as well as the parameter correspondences between the corresponding layers.

In this embodiment, step S302 in FIG. 3 is similar to step S103 in FIG. 1, and for the sake of brevity, details are not repeated here.

Step S303: Extracting multiple original model parameters from layers in the original model each having an identical network structure with the respective layer of the target model.

In this embodiment, step S303 in FIG. 3 is similar to step S104 in FIG. 1, and for the sake of brevity, details are not repeated here.

Step S304: Based on the parameter correspondences, each original model parameter is used to replace the corresponding parameter in the target model one by one, and the replaced target model is validated on the first validation set, and when the validation is passed, the original model parameter is recorded as reusable.

In this embodiment, step S304 in FIG. 3 is similar to step S105 in FIG. 1, and for the sake of brevity, details are not repeated here.

Step S305: Using all reusable parameters of the original model to replace the corresponding parameters in the target model, and after obtaining a new target model, train the new target model.

In this embodiment, step S305 in FIG. 3 is similar to step S106 in FIG. 1, and for the sake of brevity, details are not repeated here.

On the basis of the first embodiment, the method of reusing parameters of the deep learning model according the second embodiment of the present application can also select a similar data set with a large amount of data for training when there is no trained model for parameter reuse thus obtaining a model that can provide reusable parameters, and then reuse parameters between models, so as to avoid the problem that it is difficult to train a model with better results due to insufficient data.

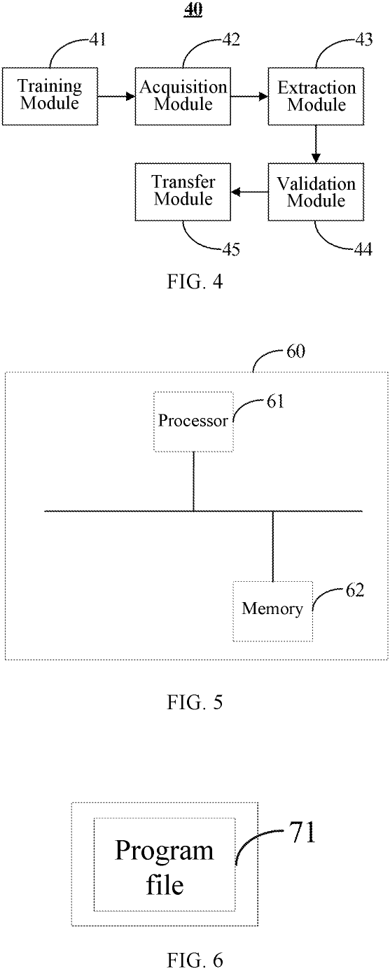

FIG. 4 is a schematic diagram of functional modules of a device for reusing parameters of a deep learning model according to a second embodiment of the present application. As shown in FIG. 4, the device 40 includes a training module 41, an acquisition module 42, an extraction module 43, a validation module 44, and a transfer module 45.

The training module 41 is used to train a target model with a pre-configured first data set, and train and obtain an original model with a pre-configured second data set training, where part or all of the network structures are identical between the target model and the original model, the data volume of the first data set is smaller than the data volume of the second data set, and the first data set includes a first training set and a first validation set.

The acquisition module 42 is used to obtain the correspondences between the layers of the target model and the original model that have identical network structures, as well as the parameter correspondences between the corresponding layers.

The extraction module 43 is used to extract multiple original model parameters from layers of the original model each having an identical network structure with the respective layer of the target model.

The validation module 44 is used to replace the corresponding parameters in the target model one by one with the corresponding original model parameter based on the parameter correspondences, and validate the replaced target model on the first validation set, and when the validation is passed, record the original model parameters as reusable.

The transfer module 45 is used to replace the corresponding parameters in the target model with all reusable parameters of the original model to obtain a new target model, and train the new target model.

For other details of implementing the technical solutions by the above various modules in the device for reusing parameters of the deep learning model according to the second embodiment, refer to the foregoing description of the method for reusing parameters of the deep learning model according to the second embodiment, which will not be repeated here.

It should be noted that the embodiments in this specification are described in a progressive manner, where each embodiment focuses on the differences from other embodiments. For the same and similar parts in the various embodiments, refer to each other. As for the device-type embodiments, since they are basically similar to the method embodiments, the description thereof is relatively simple, and for related parts, refer to the corresponding parts of the description of the method embodiments.

Referring to FIG. 5, which is a schematic diagram of a terminal according to an embodiment of the present application. As shown in FIG. 5, the terminal 60 includes a processor 61 and a memory 62 coupled to the processor 61.

The memory 62 stores program instructions for realizing a method for reusing parameters of a deep learning model described in any one of the above embodiments.

The processor 61 is used to execute the program instructions stored in the memory 62 to realize parameter reuse across different deep learning models.

The processor 61 may also be referred to as a CPU (Central Processing Unit). The processor 61 may be an integrated circuit chip with signal processing capabilities. The processor 61 may also be a general-purpose processor, a digital signal processor (DSP), an application-specific integrated circuit (ASIC), a field programmable gate array (FPGA) or other programmable logic devices, discrete gate or transistor logic devices, or discrete hardware components. A general purpose processor may be a microprocessor or any conventional processor or the like.

Referring to FIG. 6, FIG. 6 is a schematic diagram of a storage medium according to an embodiment of the present application. The storage medium in the embodiments of the present application stores a program file 71 capable of implementing all the above-mentioned methods, where the program file 71 may be stored in the above-mentioned storage medium in the form of a software product, and include several instructions to cause a computer device (which may be a personal computer, a server, or a network device, etc.) or a processor that executes all or part of the steps of the methods described in the various embodiments of the present application. The aforementioned storage media include: U disk, mobile hard drive, read-only memory (ROM), random access memory (RAM), magnetic disk, or optical disk or any other media that can store program codes, or computers, servers, mobile phones, terminal devices such as tablets.

In the several embodiments provided in this application, it should be understood that the disclosed system, device and method can be implemented in other ways. For example, the device embodiments described above are only illustrative. For example, the division of units is only a division of logical functions. In actual implementation, there may be other division methods. For example, multiple units or components can be combined or integrated to another system, or some features may be ignored or not implemented. In another point, the mutual coupling or direct coupling or communication connection shown or discussed may be realized through some interfaces, and the indirect coupling or communication connection of devices or units may be in electrical, mechanical or other forms.

In addition, the various functional units in the various embodiment of the present application may be integrated into one processing unit, or each unit may exist separately physically, or two or more units may be integrated into one unit. The above-mentioned integrated units can be implemented in the form of hardware or in the form of software functional units. The foregoing merely depicts some illustrative embodiments of the present application, and is not intended to limit the scope of the present disclosure. Any equivalent structural to process changes made on the basis of the contents of the description and drawings of the present disclosure, or any direct or indirect use of the present disclosure on other related technical fields shall all be included in the scope of protection of the present disclosure.

What is claimed is:

1. A method for reusing parameters of a deep learning model, comprising:
obtaining a target model based on a pre-configured data set, the pre-configured data set comprising a training set and a validation set;
obtaining a pre-trained original model, wherein part or all of network structures are identical between the target model and the original model;
obtaining correspondences between layers of the target model and the original model that have identical network structures, and obtaining parameter correspondences between corresponding layers of the target model and the original model;
extracting a plurality of original model parameters from the layers of the original model each having an identical network structure with the respective layer of the target model;
using the plurality of original model parameters to replace one by one the corresponding parameters of the target model based on the parameter correspondences, validating the replaced target model with the validation set, and each time when the validation is passed, recording that the corresponding original model parameter is reusable; and
using all reusable parameters of the original model to replace the corresponding parameters of the target model to obtain a new target model, and training the new target model.

2. The method as recited in claim 1, wherein the operations of validating the replaced target model, and each time when the validation is passed, recording that the corresponding original model parameter is reusable comprise:
obtaining a first result derived from training the target model with the training set;
validating the replaced target model with the validation set, and recording a second result of the validation;
determining whether a difference between the first result and the second result lies within a preset range; and
when the difference between the first result and the second result lies within a preset range, determining that the validation is passed and recording that the corresponding original model parameter is reusable.

3. The method as recited in claim 1, wherein the operation of training the new target model comprises:
training the new target model directly using the training set.

4. The method as recited in claim 1, wherein the operation of training the new target model comprises:
freezing reusable original model parameters in the new target model, and train the new target model using the training set.

5. The method as recited in claim 1, further comprising the following operation prior to training the target model with the pre-configured data set:
preprocessing the dataset.

6. A method for reusing parameters of a deep learning model, comprising:
training a target model with a pre-configured first data set, and training an original model with a pre-configured second data set, wherein part or all of network structures are identical between the target model and the original model, and the pre-configured first data set comprises a first training set and a first validation set;
obtaining correspondences between layers of the target model and the original model that have identical network structures, and parameter correspondences between corresponding layers of the target model and the original model;
extracting a plurality of original model parameters from layers of the original model each having an identical network structure with the respective layer of the target model;
using each of original model parameters to replace the corresponding parameter in the target model one by one based on the parameter correspondences, validating the replaced target model with the first validation set, and each time when the validation is passed, recording that the corresponding original model parameter is reusable;
using all reusable parameters of the original model to replace the corresponding parameters in the target model to obtain a new target model, and training the new target model.

7. A terminal, comprising a processor and a memory coupled to the processor, wherein the memory stores program instructions for realizing a method for reusing parameters of a deep learning model; and wherein the processor is configured to execute the program instructions stored in the memory to realize parameter reuse across different deep learning models; wherein the method comprises:
obtaining a target model based on a pre-configured data set, the pre-configured data set comprising a training set and a validation set;
obtaining a pre-trained original model, wherein part or all of network structures are identical between the target model and the original model;
obtaining correspondences between layers of the target model and the original model that have identical network structures, and obtaining parameter correspondences between corresponding layers of the target model and the original model;
extracting a plurality of original model parameters from the layers of the original model each having an identical network structure with the respective layer of the target model;
using the plurality of original model parameters to replace one by one the corresponding parameters of the target model based on the parameter correspondences, validating the replaced target model with the validation set, and each time when the validation is passed, recording that the corresponding original model parameter is reusable; and
using all reusable parameters of the original model to replace the corresponding parameters of the target model to obtain a new target model, and training the new target model.

8. The terminal as recited in claim 7, wherein the operations of validating the replaced target model, and each time when the validation is passed, recording that the corresponding original model parameter is reusable comprise:
obtaining a first result derived from training the target model with the training set;
validating the replaced target model with the validation set, and recording a second result of the validation;
determining whether a difference between the first result and the second result lies within a preset range; and
when the difference between the first result and the second result lies within a preset range, determining that the validation is passed and recording that the corresponding original model parameter is reusable.

9. The terminal as recited in claim 7, wherein the operation of training the new target model comprises:
training the new target model directly using the training set.

10. The terminal as recited in claim 7, wherein the operation of training the new target model comprises:
freezing reusable original model parameters in the new target model, and train the new target model using the training set.

11. The terminal as recited in claim 7, further comprising the following operation prior to training the target model with the pre-configured data set:
preprocessing the dataset.

12. A terminal, comprising a processor and a memory coupled to the processor, wherein the memory stores program instructions for realizing the method as recited in claim 6; and wherein the processor is configured to execute the program instructions stored in the memory to realize parameter reuse across different deep learning models.

13. A storage medium, storing a program file capable of realizing the method as recited in claim 1.

14. A storage medium, storing a program file capable of realizing the method as recited in claim 2.

15. A storage medium, storing a program file capable of realizing the method as recited in claim 3.

16. A storage medium, storing a program file capable of realizing the method as recited in claim 4.

17. A storage medium, storing a program file capable of realizing the method as recited in claim 5.

18. A storage medium, storing a program file capable of realizing the method as recited in claim 6.
